(19) United States
(12) Patent Application Publication
(10) Pub. No.: US 2005/0071984 A1
(43) Pub. Date: Apr. 7, 2005

(54) Tackable and markable dry erase board and method of making same

(75) Inventor: Steve Beno, Gurnee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: General Binding Corporation, Skokie, IL (US)

(21) Appl. No.: 10/957,975

(22) Filed: Oct. 4, 2004

Related U.S. Application Data
(63) Continuation of application No. 09/799,830, filed on Mar. 6, 2001, now Pat. No. 6,837,715.

(51) Int. Cl. B23P 11/00; B21B 1/46

(52) U.S. Cl. 29/527.3; 29/428

(57) ABSTRACT

Tackable and markable dry erase display boards which have no frame and which may be die cut from moldable foam material capable of receiving and holding mounting pins and substantially closing after a pin is withdrawn. Such boards are light weight and can be mounted on substantially any desired surface without hardware or tools, and can be fabricated in substantially any desired color. The boards may have convenient means for holding accessories such as an eraser or marking implement.

### CROSS-REFERENCE TO RELATED PATENT APPLICATIONS

This patent application is a continuation of copending U.S. patent application Ser. No. 09/799,830, filed Mar. 6, 2001.

### FIELD OF THE INVENTION

This invention pertains to boards which may be used to display removably tacked on and written material, but which have no frame for containing the tackable and writable surfaces of the board.

### BACKGROUND OF THE INVENTION

Dry erase boards and tackable display boards are old in the art. These boards usually may have a tackable surface, such as cork or fiber, and a markable surface, such as melamine, porcelain coated paper, metal or film. The tackable surface preferably permits a note or display to be attached to the board by a push pin or thumb tack, and preferably the pin or tack may be removed to permit mounting of another note or display. Preferably the markable surface may be erased with an eraser or wiped with a cloth, to permit another marking to be made on the markable surface.

Examples of such dry erase boards and tackable display boards may be found in several prior art patents, such as

| | |
|---|---|
| Boone et al., U.S. Pat. No. 5,527,568 | Lassoff, U.S. Pat. No. 5,655,323 |
| Davis et al., U.S. Pat. No. 5,658,635 | Davis et al., |
| Bianoco, U.S. Pat. No. 5,948,498 | U.S. Pat. No. 5,928,756 |
| | Davis et al., |
| | U.S. Pat. No. 5,979,663 |

and others

However, all of these patent require a frame or backing and in no known patent or prior art disclosure can a combination board be mounted without a frame or backing. Additionally, the presences of the frame or backing inhibits the decorative use of more than one assembled shaped boards, for example, where one board is circular shaped and fits into another board which is of a mating crescent shape.

### BRIEF SUMMARY OF THE INVENTION

Combination boards embodying the present invention can have both a tackable surface and a markable surface, and the board may be die cut in any desired shape permitting one or more boards to be die cut and assembled into any decorative form, such as free forms, geometric forms or circular forms, or a combination of such forms, without the use of special backing, frames or the like. These forms permit the fabrication of such combination boards without extra manufacturing steps or special jigs or machines to fabricating and mount and secure frames or backing.

Additionally, a board embodying the present invention may be fabricated with an eraser or pen holder and the erasable member may be mounted at almost any position, permitting great versatility for such a board. Preferably the board is fabricated from a moldable foam material, which can be die cut to any desirable shape but is relatively light in weight and thick enough to hold a push pin. The moldable material must also be rubber-like and capable of receiving multiple pin pricks, so that is may be used many times without leaving formed pin holes. A preferred material is ethyl vinyl acetate (or EVA) foam, which is capable of holding pins, and which has the ability for the pin hole to substantially close after a pin is withdrawn.

The preferred EVA foam also may be fabricated in almost any color, without over coatings, coverings, or any extra coloring steps. This feature permits these boards to be decorative or color coordinated in special environments.

A board embodying the present invention may have mounting means secured to it. Such mounting means may consist of magnetic strips, where the board is to be mounted on a metal partition wall or on a refrigerator, or double sided pressure sensitive tape strips, which permit the board to be mounted on most surfaces. Mounting may be accomplished without the use of any board, which is capable of receiving and holding mounting pins and which has the ability for the foam to substantially close after a pin is withdrawn.

Another object is to provide such a frame-less combination tackable foam and markable display board which can be fabricated from substantially any desired color.

Another object is to provide such a frame-less combination tackable foam and markable display board which is relatively light in weight and can be mounted on substantially any desired surface without hardware or tools.

Another object is to provide such a frame-less combination tackable foam and markable display board which has an erasable surface which may be wiped clean without any cleaners or applied moisture and reused.

Another object is to provide such a frame-less combination tackable foam and markable display board which is simple and easy to fabricate and which is easy to use and re-use.

These and other objects and advantages of the invention will become more apparent as this description proceeds, taken in conjunction with the accompanying drawings.

### BRIEF DESCRIPTION OF THE DRAWINGS

FIG. 1 is a perspective view of an exemplary dry erase and tack display board having no frame embodying the present invention.

FIG. 2 is an enlarged detail sectional view of a part of such a board showing the means for securing an accessory, such as a writing implement onto the board, taken on the line 2-2 of FIG. 1.

FIG. 3 is an enlarged sectional view of the board which also shows the means for hardware or tools.

The markable surface may consist of a thin panel of any shape or size which is glued or otherwise secured to the EVA foam. This panel may consist of a sheet of thin laminate plastic having a film surface which can be written upon. The surface may be wiped clean without any cleaners or moisture applied, and reused. Preferably, a writing implement, such as a Sanford Expo marker, or the like, may be used. A preferred material for the markable surface of the board is dry erase styrene.

### OBJECTS AND ADVANTAGES OF THE INVENTION

It is the object of the present invention to provide a dry erase and tack display board having no frame of the character referred to.

Another object is to provide a combination tackable and markable display board which has no frame or special backing.

Another object is to provide such a combination tackable and markable display board which can be die cut and assembled into substantially any convenient decorative form.

Another object is to provide such a die-cutable tackable and markable display board which can be combined and associated with another board of similar structure.

Another object is to provide such a frame-less combination tackable and markable display board which has a body structure composed of moldable material, such as ethyl vinyl acetate foam.

Another object is to provide such a frame-less combination tackable foam and markable display board which has convenient means for holding accessories such as an eraser or marking implement.

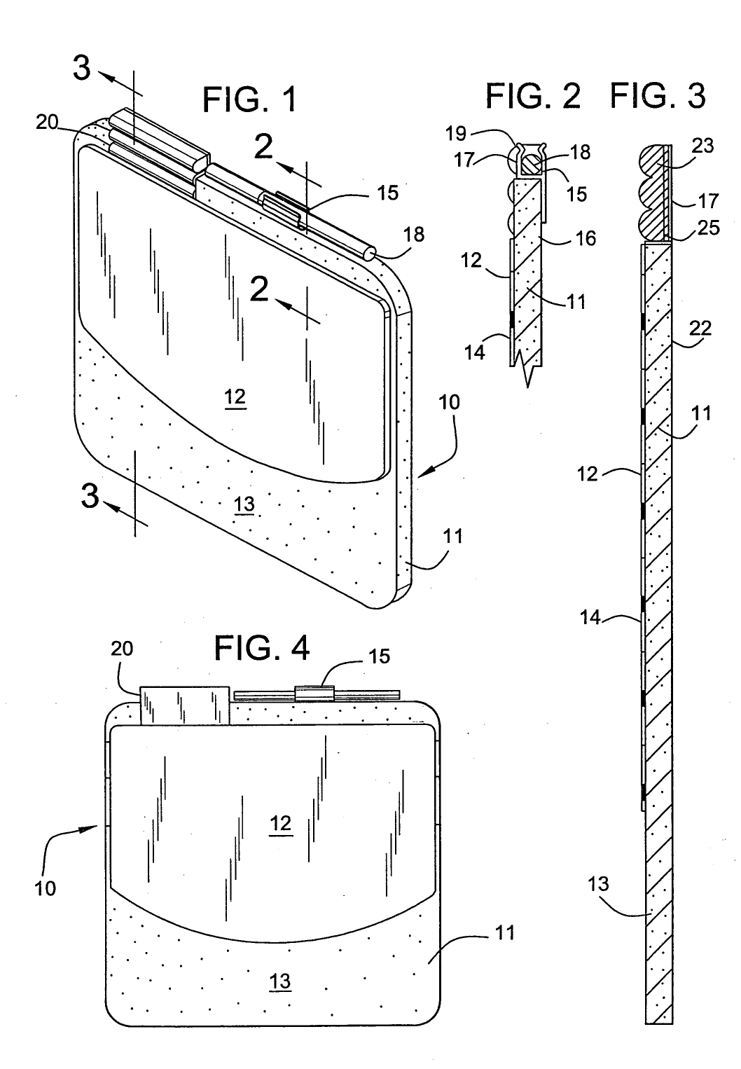

Another object is to provide a frame-less combination tackable foam and markable display securing an eraser, taken on line 3-3 of FIG. 1.

FIG. 4 is a front elevation view of the display board shown in FIG. 1.

FIG. 5 is a plan view of modified combination round and crescent boards embodying the invention which may be fit together for decorative and special purposes.

FIG. 6 is a side elevational view of the combination boards shown in FIG. 4.

FIG. 7 is an enlarged sectional view of a part of the board shown in FIG. 5 and FIG. 6.

### DESCRIPTION OF PREFERRED EMBODIMENTS

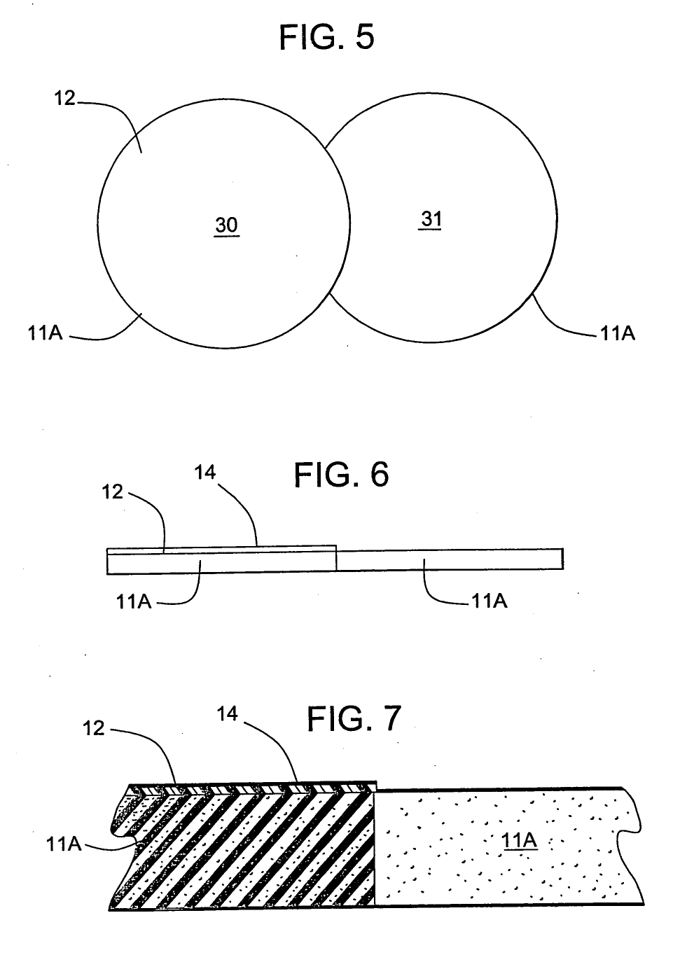

With reference to the accompanying drawings and particularly to FIGS. 1-4, a display board 10 embodying the present invention preferably has a body 11 of molded foam material, which may be die cut from EVA foam or similar material which is light in weight and has the ability to receive and hold push pins or thumb tacks so that the pins or tacks may be removed and the holes will substantially close, to permit later mounting of other materials onto the board. The foam board has a sufficient thickness and rigidity to maintain its shape without the need for a separate structural frame or structural backing. Secured onto the face side 13 of the foam body 11 is a sheet 12 of markable material, such a dry erase styrene, which has a surface 14 which may be written or marked upon and which may be erased. This sheet 12 is preferably appropriately secured to the body 11 by flue or cement.

A clip 15 may be glued to the rear side 16 of the foam body 11 and may have a channel 17 for receiving therein a pen 18 or other marking implement. This channel 17 may have snap engaging flexible legs 19 to stow the pen 18 in a desired position when not in use. A portion 20 of the foam body 11 may be cut away, and a small panel 21 may be secured, as by glue, to the rear side 22 of the board body for holding an eraser 23 in the cut away portion 20, and this eraser 23 may have a series of parallel ribs 24, facilitating holding the same by hand, and a dry absorbent erasing surface 25, such as felt, for use as an eraser to wipe clean marking placed on the surface 14 of the dry erase sheet 12.

Mounting of the board 10 may be accomplished by any conventional means (not shown) such as double sides pressure sensitive tape or pressure sensitive magnetic tape or other means.

As shown in FIGS. 5-7, foam bodies 11a may be die cut into any shape, such as a circle 30 and a crescent 31. One or both of these foam bodies 11a may comprise a sheet 12 having a markable surface 14. They dry cut foam bodies 11a may be nested together as shown, for decorative or other purposes. Similar cooperative foam sheets may be used, such a geometric or special shapes, utilizing the same foam tackboard and erasable materials.

While preferred embodiments of the invention have been shown and described, it is not desired that the invention should be limited to the structure of element shown, except as limited by the appended claims.

1. A method of manufacturing a tackable and markable dry-erase board assembly for receiving at least one tack and displaying an erasable writing material, the method comprising:
(a) providing a board comprising an integral body of a plastic foam material, the board having sufficient thickness and rigidity to maintain its shape without the need for a separate structural frame or structural backing, the board further comprising a mounting surface capable of receiving and holding a tack; and
(b) securing a panel to a portion of the board mounting surface, the panel having a surface adapted to display the erasable writing material.

2. The method of claim 1 wherein the plastic foam material is capable substantially closing a hole made by the tack when the tack is withdrawn such that the same hole is capable of holding the tack for more than one time.

3. The method of claim 1 further comprising the step of die-cutting the board from the plastic foam material.

4. The method of claim 1 further comprising the step of die-cutting the board from a sheet of the plastic foam material.

5. The method of claim 1 further comprising the step of molding the plastic foam material.

6. The method of claim 1 further comprising the step of providing a second board comprising a body of a plastic foam material, the second board having sufficient thickness and rigidity to maintain its molded shape without the need for a separate structural frame or structural backing, the second board further comprising a mounting surface capable of receiving and holding a tack.

7. The method of claim 6 further comprising the step of coupling the board and the second board together.

8. The method of claim 6 further comprising the step of securing a second panel to a portion of the second board mounting surface

9. The method of claim 8 wherein the second panel comprises a surface adapted to display the erasable writing material.

10. The method according to claim 1 further comprising the step of coupling at least one of a writing implement or an eraser to at least one of the board or panel.

11. The method according to claim 1 wherein the step of securing the panel comprises the step of securing the panel to a portion of the board mounting surface wherein the panel is spaced from at least a portion of a peripheral edge of the board.

12. The method according to claim 1 further comprising the step of securing a mounting structure to the board.
